(19) United States
(12) Patent Application Publication
(10) Pub. No.: US 2013/0310004 A1
(43) Pub. Date: Nov. 21, 2013

(54) NETWORK DEVICE AND METHOD FOR NOTIFYING A CLIENT OF KEY OF THE NETWORK DEVICE

(71) Applicant: HON HAI PRECISION INDUSTRY CO., LTD., New Taipei (TW)

(72) Inventor: SHU-MIN YANG, New Taipei (TW)

(73) Assignee: HON HAI PRECISION INDUSTRY CO., LTD., New Taipei (TW)

(21) Appl. No.: 13/875,318

(22) Filed: May 2, 2013

(30) Foreign Application Priority Data
May 18, 2012 (TW) 101117699

(51) Int. Cl. H04W 12/04

(52) U.S. Cl. CPC H04W 12/04
USPC 455/411

(57) ABSTRACT

A network device, providing Internet service to at least a client which corresponds to at least a phone with a phone number, includes at least one processor, a storage system storing the phone number, a mobile communication module that communicates with the phone via a mobile communication network, a key management module detecting whether the key of the network device notifies the phone. The mobile communication module reads the phone number stored in the storage system if the key of the network device is notifies the phone and creates a short message according to the key, and sends the short message to the phone according to the phone number via the mobile communication network.

### BACKGROUND

1. Technical Field

Embodiments of the present disclosure generally relate to network communication, and more particularly to a network device and a method for notifying a key of a network device.

2. Description of Related Art

A network device, providing Internet service to a client, offers a key to the client to access Internet service.

However, the key is easy to be forgotten. As a result, the network device usually fails to notify a client of a key quickly and secretly.

### BRIEF DESCRIPTION OF THE DRAWINGS

FIG. 1 is a schematic diagram of an application environment of one embodiment of a network device in accordance with the present disclosure.

FIG. 2 is a block diagram of one embodiment of functional modules of the network device in FIG. 1.

FIG. 3 is a block diagram of another embodiment of functional modules of the network device in FIG. 1.

FIG. 4 is a block diagram of another embodiment of functional modules of the network device in FIG. 1.

FIG. 5 is a flowchart of one embodiment of a method for notifying a client of a key of a network device.

FIG. 6 is a transmission diagram of one embodiment of a method for notifying a client of a key of a network device.

FIG. 7 is a transmission diagram of another embodiment of a method for notifying a client of a key of a network device.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or assembly. One or more software instructions in the modules may be embedded in firmware such as in an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

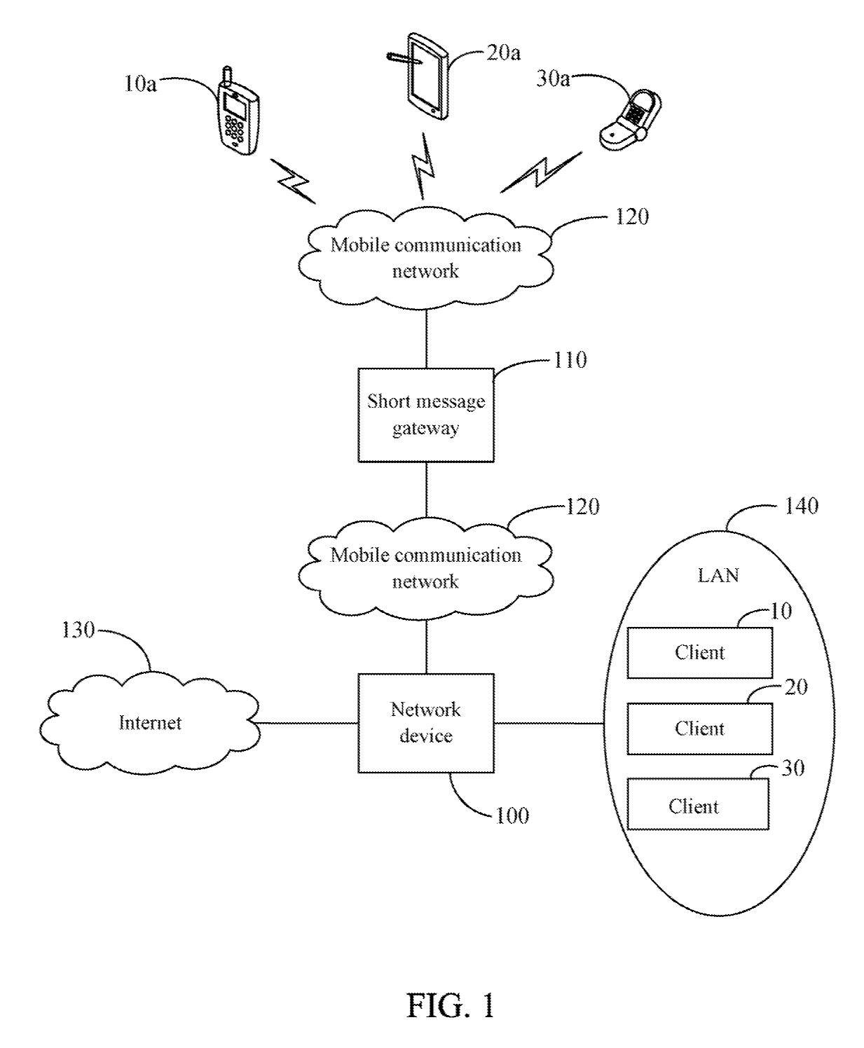

FIG. 1 is a schematic diagram of an application environment of one embodiment of a network device 100 in accordance with the present disclosure. In the present embodiment, a plurality of clients, such as a client 10, a client 20 and a client 30, are in a local area network (LAN) 140, and the clients are connected to Internet 130 by a network device 100. The network device 100 provides Internet service for the plurality of clients in the LAN 140. The client 10, the client 20, and the client 30 correspond to a phone 10a, a phone 20a, and a phone 30a respectively.

When the network device 100 notifies the plurality of clients of a key of the network device 100, the network device 100 creates a short message according to the key and sends the short message to a short message gateway 110 via a mobile communication network 120. The short message gateway 110 sends the short message to the client 10, the client 20 and the client 30 via the mobile communication network 120. The mobile communication network 120 may be selected from a group including a second generation (2G) mobile communication network, a third generation (3G) mobile communication network and a fourth generation (4G) mobile communication network.

In one embodiment, the network device 100 may wirelessly communicate with the plurality of clients, or may communicate with the plurality of clients by a wired connection. Similarly, the network device 100 may be connected to the Internet 130 wirelessly or by a physical connection.

In one embodiment, the network device 100 is selected from a group including a wireless broad band gateway, a mobile network gateway and a wireless access point. The network device 100 may communicate with a client in the LAN 140 according to an IEEE 802.11 protocol.

The network device 100 transmits its key stored in the short message to a client in the LAN 140. The short message, transmitted by a point-to-point communication that can by established easily, is hard to be stolen and occupies a small capacity. Moreover, a short message can be stored in a short message service center for almost six months until the phone concerned is capable of receiving the short message. In conclusion, the short message is an easy, safe and quick means to notify a user of the key.

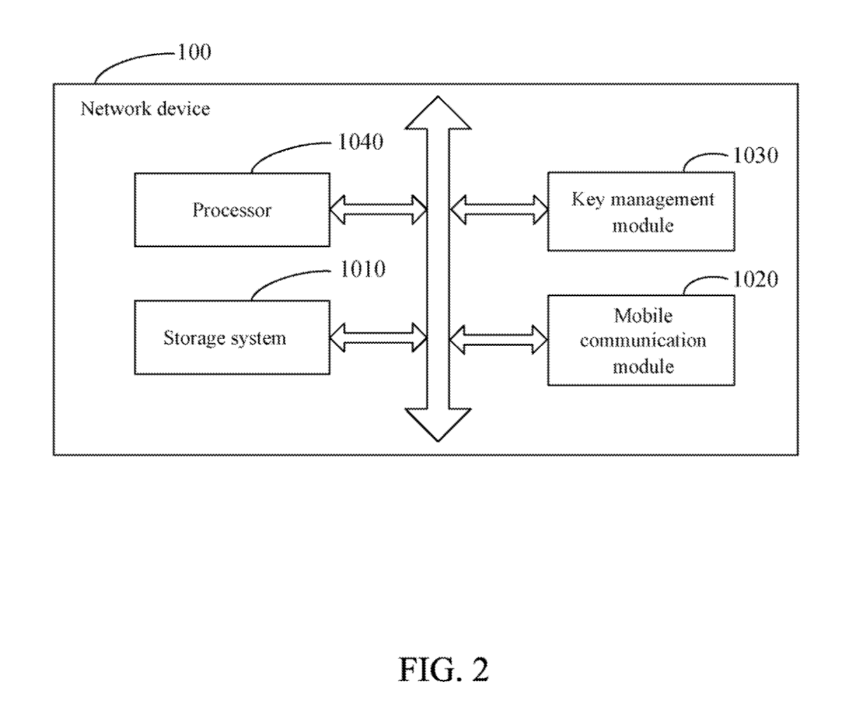

FIG. 2 is a block diagram of one embodiment of functional modules of the network device 100. In the present embodiment, the network device 100 includes a storage system 1010, a mobile communication module 1020, a key management module 1030 and a processor 1040. The storage system 1010 stores the phone numbers of the phone 10a, the phone 20a and the phone 30a. The key management module 1030 detects whether the key of the network device 100 is required to notify the phone 10a, the phone 20a and the phone 30a. In one embodiment, the key is selected from a group including a security key and a wireless encryption method in accordance with an IEEE 802.11 protocol. The mobile communication module 1020 reads the phone numbers stored in the storage system 1010 upon the condition that the key of the network device notifies the phones and creates a short message according to the key, and sends the short message to the short message gateway 110 via the mobile communication network 120. The short message gateway 110 transmits the short message to the phone 10a, the phone 20a and the phone 30a via the mobile communication network 120. The client 10, the client 20 and the client 30 can know the key of the network device 100 through the short message received by the phone 10a, the phone 20a and the phone 30a. The programs of the key management module 1030 are executed by the processor 1040. In one embodiment, the mobile communication module 1020 may be selected from a group including a second generation (2G) mobile communication module, a third generation (3G) mobile communication module and a fourth generation (4G) mobile communication module.

In one embodiment, if the mobile communication module 1020 is the 2G mobile communication module, the storage system 1010 is a subscriber identity module (SIM), and the SIM stores the phone numbers into its telephone book.

In another embodiment, if the mobile communication module 1020 is the 3G or 4G mobile communication module, the storage system 1010 is a universal subscriber identity module (USIM), and the USIM stores the phone numbers into its telephone book.

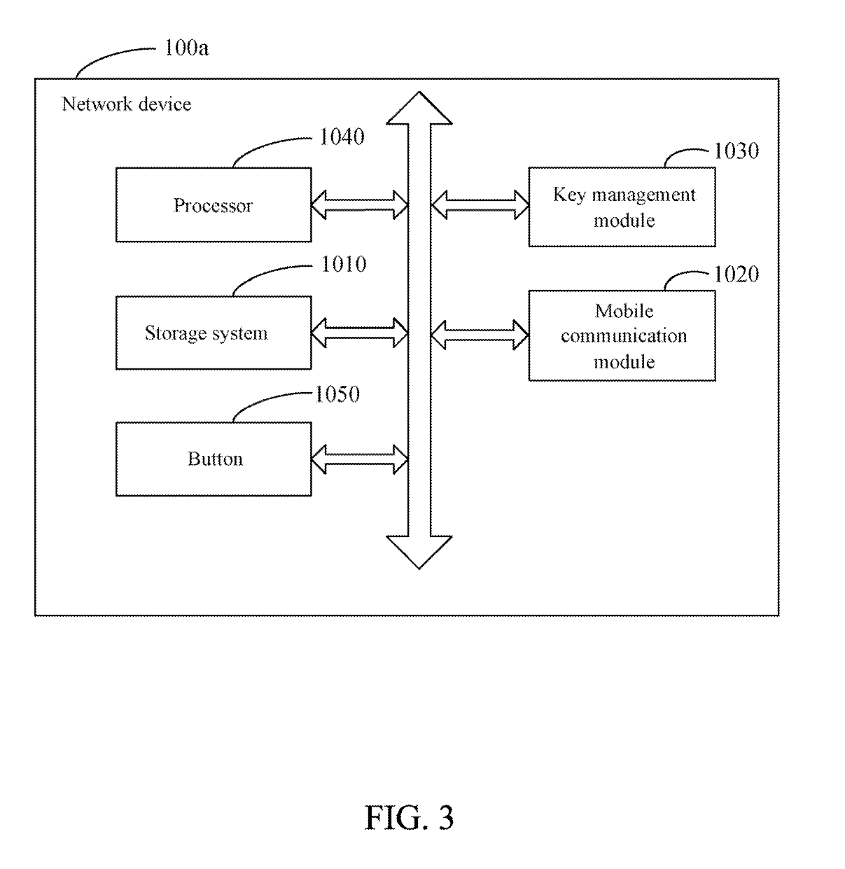

FIG. 3 is a block diagram of another embodiment of functional modules of a network device 100a. The network device 100a includes all of the modules of the network device 100 and a button 1050 in particular. The key management module 1030 changes the key upon actuation of the button 1050, and then the mobile communication module 1020 creates the short message according to the key and sends the short message to the phone 10a, the phone 20a and the phone 30a according to the phone numbers. As a result, the key of the network device 100a can be updated at any time.

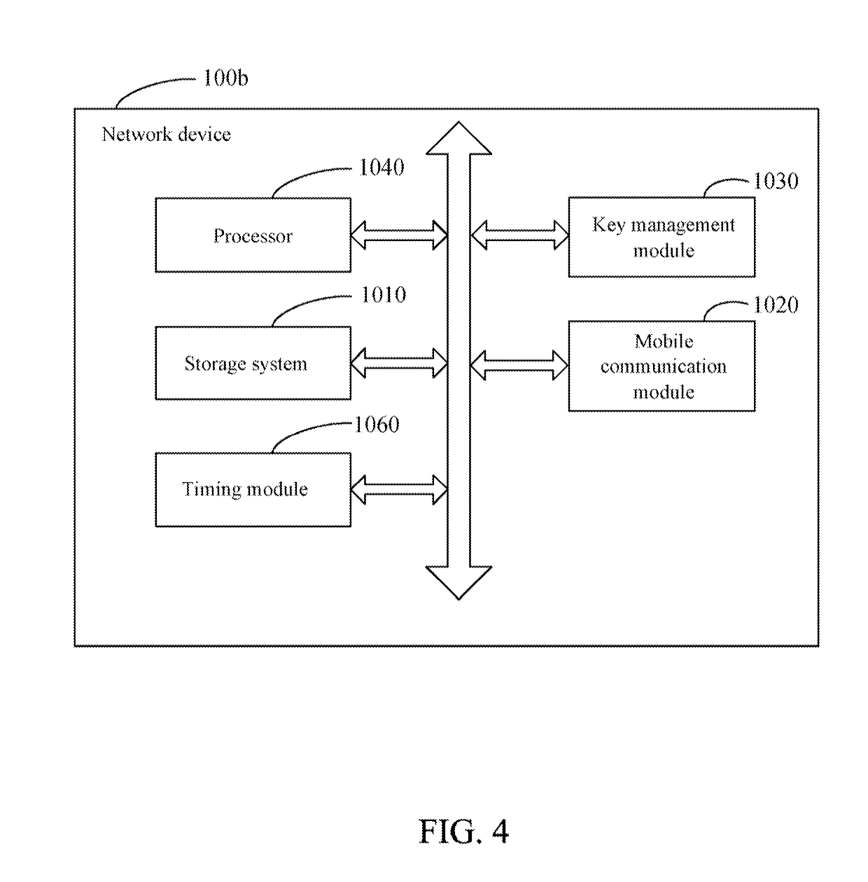

FIG. 4 is a block diagram of another embodiment of functional modules of the network device 100b. The network device 100b includes all of the modules of the network device 100 and a timing module 1060 in particular. The timing module 1060 reminds the key management module 1030 to change the key at a predefined interval, and the key management module 1030 changes the key according to the reminding of the timing module 1060 and the mobile communication module 1020 creates the short message according to the key. As a result, the network device 100b can operate in a safe situation.

The method for triggering the update of a key of the network device 100 is not limited to the button 1050 and the timing module 1060 as mentioned above. For example, if the network device 100 provides a window displaying an icon to interact with a user. A user can trigger the icon by a mouse to update the key of the network device 100.

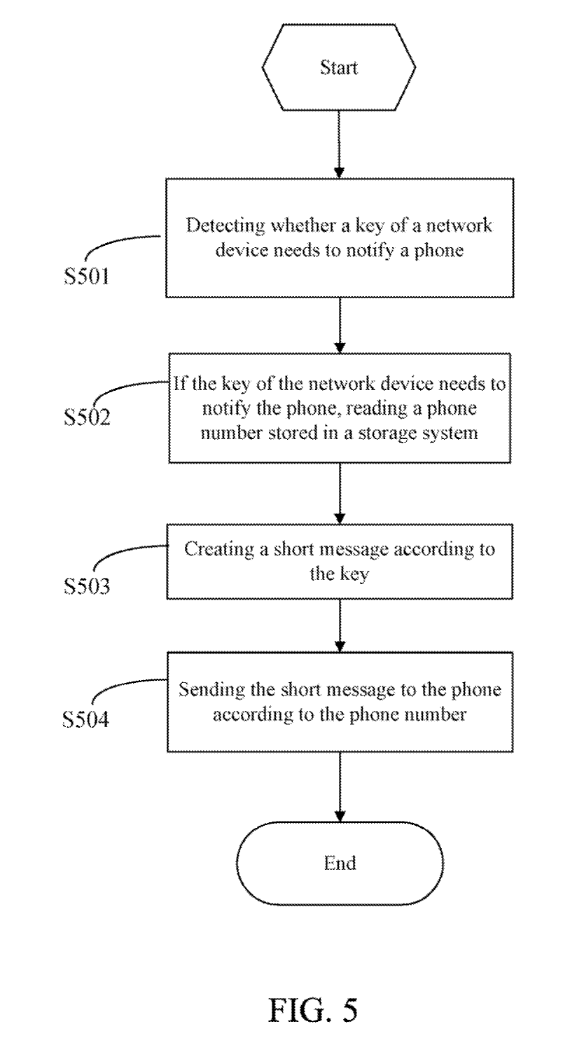

FIG. 5 is a flowchart of one embodiment of a method for notifying a client of a key of the network device 100. In one embodiment, the method functions in the application environment in FIG. 1 and by the modules in FIG. 2 in the manner following.

In block S501, the network device 100 detects whether the key of the network device needs to notify a phone 10a, a phone 20a and a phone 30a.

In block S502, the mobile communication module 1020 reads the phone numbers of the phone 10a, the phone 20a and the phone 30a which are stored in the storage system.

In block S503, the mobile communication module 1020 creates a short message according to the key received from the key management module 1030.

In block S504, the mobile communication module 1020 sends the short message to the short message gateway 110 via the mobile communication network 120. The short message gateway 110 transmits the short message to the phone 10a, the phone 20a and the phone 30a via the mobile communication network 120. In one embodiment, the key is selected from a group including a security key and a wireless encryption method in accordance with an IEEE 802.11 protocol. The client 10, the client 20 and the client 30 can know the key of the network device 100 through the short message received by the phone 10a, the phone 20a and the phone 30a.

In one embodiment, the network device 100 is selected from a group including a wireless broad band gateway, a mobile network gateway and a wireless access point.

In one embodiment, if the mobile communication module 1020 is a second generation (2G) mobile communication module, the storage system 1010 is a subscriber identity module (SIM), and the SIM stores the phone numbers into its telephone book.

In another embodiment, if the mobile communication module 1020 is a third generation (3G) mobile communication module or a fourth generation (4G) mobile communication module, the storage system 1010 is a universal subscriber identity module (USIM), and the USIM stores the phone numbers into its telephone book.

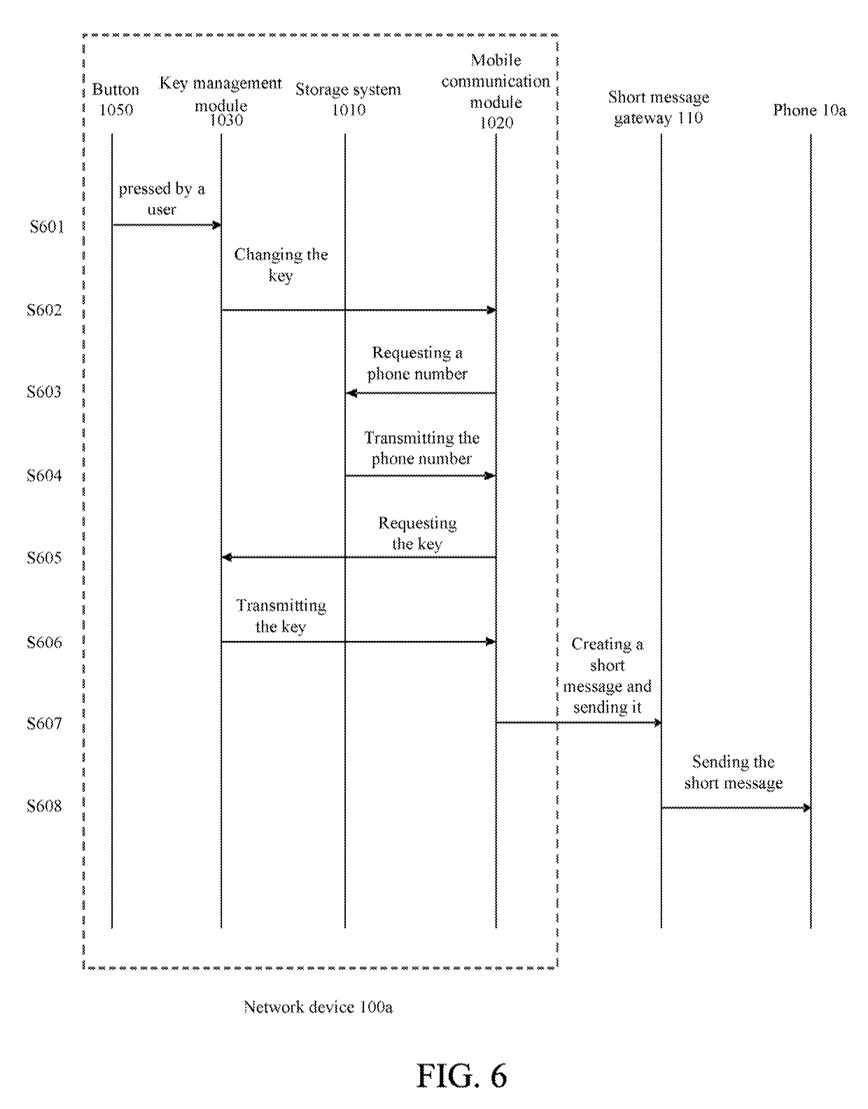

FIG. 6 is a transmission diagram of one embodiment of a method for notifying a client of a key of a network device 100a. In one embodiment, the method functions in the application environment in FIG. 1 and by the modules in FIG. 3 in the manner following. The following takes the phone 10a as an example.

In block S601, the button 1050 is pressed by a user.

In block S602, the key management module 1030 changes the key of the network device 100a.

In block S603, the mobile communication module 1020 requests a phone number of the phone 10a stored in the storage system 1010.

In block S604, the storage system 1010 transmits the phone number of the phone 10a to the mobile communication module 1020.

In block S605, the mobile communication module 1020 requests the key management module 1030 for the key of the network device 100a.

In block S606, the key management module 1030 transmits the key of the network device 100a to the mobile communication module 1020.

In block S607, the mobile communication module 1020 creates a short message according to the key, and sends the short message to the short message gateway 110 according to the phone number.

In block S608, the short message gateway 110 sends the short message to the phone 10a. As a result, the client 10 knows the key by the short message.

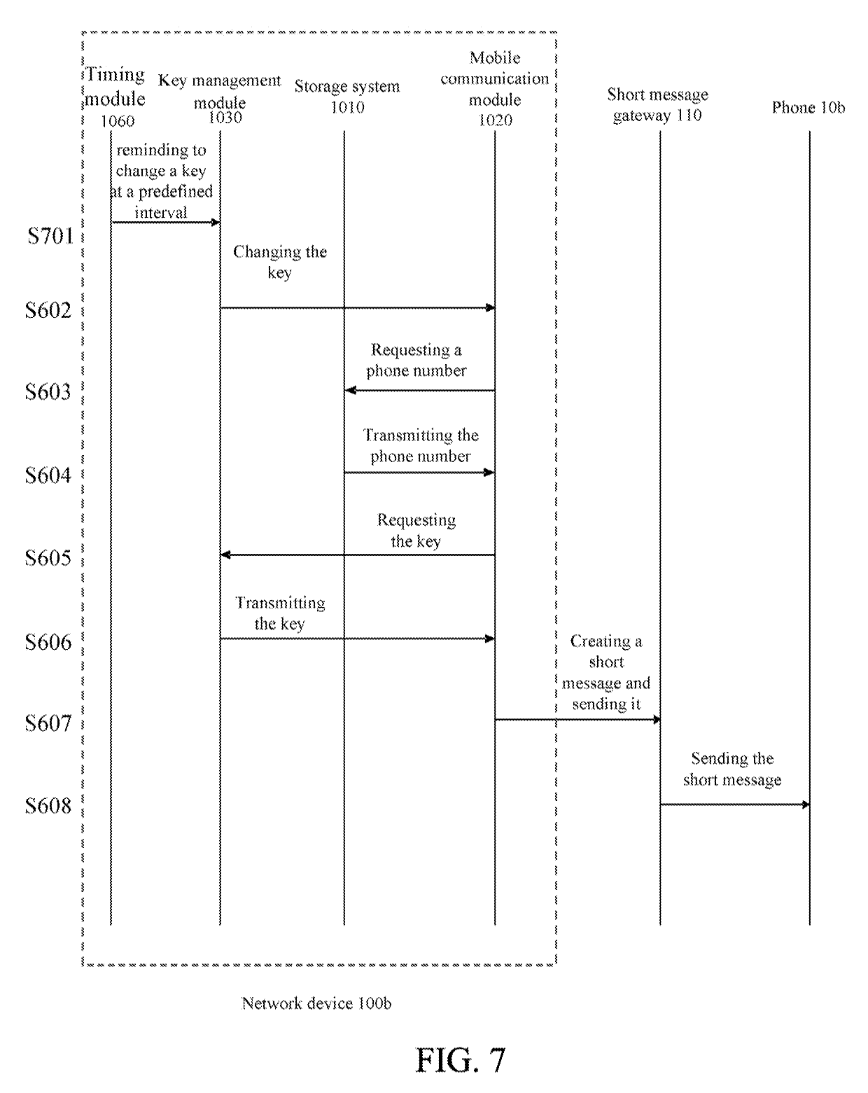

FIG. 7 is a transmission diagram of another embodiment of a method for notifying a client of a key of a network device 100b. In one embodiment, the method functions in the application environment in FIG. 1 and by the modules in FIG. 4 in the manner following. FIG. 7 differs from FIG. 6 in block S601 and S701. In block S701, the timing module 1060 reminds the key management module 1030 to change the key of the network device 100b at a predefined interval, such as seven days.

What is claimed is:

1. A network device providing Internet service to a client corresponding to a phone with a phone number, the network device communicating with the phone via a mobile communication network, the network device comprising:
at least one processor;
a storage system storing the phone number;
one or more programs that are stored in the storage system and are executed by the at least one processor, comprising:
a key management module, detecting whether a key of the network device is required to notify the phone;
a mobile communication module, reading the phone number stored in the storage system, creating a short message according to the key and sending the short message to the phone according to the phone number, upon the condition that the key of the network device notifies the phone.

2. The network device as claimed in claim 1, further comprising a button, wherein the key management module changes the key upon actuation of the button, and the mobile communication module creates the short message according to the changed key and sends the short message to the phone according to the phone number.

3. The network device as claimed in claim 1, further comprising a timing module that reminds the key management module to change the key at a predefined interval, wherein the key management module changes the key according to the reminding of the timing module and the mobile communication module creates the short message according to the changed key and sends the short message to the phone according to the phone number.

4. The network device as claimed in claim 1, wherein the network device is selected from the group comprising a wireless broad band gateway, a mobile network gateway, and a wireless access point.

5. The network device as claimed in claim 1, wherein the mobile communication module is selected from a group comprising a third generation (3G) mobile communication module and a fourth generation (4G) mobile communication module.

6. The network device as claimed in claim 5, wherein the storage system comprises a subscriber identity module, and the subscriber identity module stores the phone number into a phone book of the subscriber identity module.

7. The network device as claimed in claim 1, wherein the key is selected from a group comprising a security key and a wireless encryption method.

8. A method for notifying a client of a key of a network device, wherein the network device provides Internet service to the client, the client corresponds to a phone and the phone corresponds to a phone number, and the network device comprises a storage system storing the phone number and communicates with the phone via a mobile communication network, the method comprising:
detecting whether the key of the network device notifies the phone;
reading the phone number stored in the storage system upon detecting that the key of the network device notifies the phone, creating a short message according to the key and sending the short message to the phone according to the phone number.

9. The method as claimed in claim 8, further comprising:
providing a button on the network device;
changing the key upon actuation of the button, and creating a short message according to the changed key and sending the short message to the phone according to the phone number.

10. The method as claimed in claim 8, further comprising:
reminding the network device to change the key at a predefined interval;
changing the key according to the reminding of the timing module, and creating a short message according to the changed key and sending the short message to the phone according to the phone number.

11. The method as claimed in claim 8, wherein the network device is selected from the group comprising a wireless broad band gateway, a mobile network gateway and a wireless access point.

12. The method as claimed in claim 8, wherein the mobile communication module is selected from the group comprising a third generation (3G) mobile communication module and a fourth generation (4G) mobile communication module.

13. The method as claimed in claim 8, wherein the storage system comprises a subscriber identity module, and the subscriber identity module stores the phone number into a telephone book of the subscriber identity module.

14. The method as claimed in claim 8, wherein the key is selected from the group comprising a security key and a wireless encryption method.
